(19) United States
(12) Patent Application Publication
(10) Pub. No.: US 2022/0355718 A1
(43) Pub. Date: Nov. 10, 2022

(54) MOTOR VEHICLE FLOOR TRIM, LUGGAGE COMPARTMENT TRIM OR LOAD FLOOR TRIM WITH TEXTURED NEEDLE-PUNCHED CARPET SURFACE

(71) Applicant: ADLER PELZER HOLDING GMBH, Hagen (DE)

(72) Inventors: Volkmar SCHULZE, Schierling (DE); Frank FALK, Albstadt (DE); Ray SINGH, Schwelm (DE)

(73) Assignee: ADLER PELZER HOLDING GMBH, Hagen (DE)

(21) Appl. No.: 17/624,512

(22) PCT Filed: Jul. 1, 2020
(86) PCT No.: PCT/EP2020/068555

§ 371 Date: Jan. 3, 2022

(30) Foreign Application Priority Data
Jul. 4, 2019 (DE) 10 2019 118 163.1

(51) Int. Cl. B60N 3/04

(52) U.S. Cl. CPC B60N 3/048; B60N 3/042

(57) ABSTRACT

A method is disclosed for producing a three-dimensionally deformable velour carpet for a floor trim, luggage compartment trim or load floor trim for motor vehicles, the carpet surface of which has a needled structure on the visible side, as well as the trim itself.

The subject matter of the invention is a method for producing a three-dimensionally deformable velour carpet for a floor trim, luggage compartment trim or load floor trim for motor vehicles, the carpet surface of which has a needled structure on the visible side, as well as the trim itself.

Especially due to the development of e-vehicles, design/styling is looking for alternative solutions in the deformable carpet surface compared to plain, smooth flat needlepunched-nonwoven, velour and tufted carpet.

In the case of motor vehicles with rear doors (station wagons) and fold-down rear seat backs, this styling also applies in particular to the luggage compartment and the loading floor, since when the rear door is open and the rear seat backs are folded down, one looks from the rear into the interior of the motor vehicle thus released. Both the luggage compartment and the passenger compartment must then embody a uniform, coherent styling.

In the prior art, various embodiments of carpet facings for motor vehicle floor trims, luggage compartment trims as well as load floor trims are known, namely in particular tufted, velour and flat needlepunched-nonwoven carpets.

For tufted carpets, in particular PA6.6, PA6, PP, rPA and PET, rPET as well as the corresponding bio-based polyamides (PA 5.10; PA 6.10); and for velour and flat needlepunched-nonwoven carpets, PET, PET/PP, PP, PA/PET and rPET are mainly used as yarn/fibre material.

In the prior art, processes for the production of velour carpets are known, see inter alia DE 44 09 771 A1, DE 29 00 935 C2 and DE 10 2008 026 968 A1.

A velour fleece is a refined needlepunched-nonwoven in which a fibre pile is created in a pre-fabricated fleece material by means of needling in a running homogeneous brush belt. If this is then, in a further process step, sheared to a defined pile height, a sheared velour is obtained.

A velour carpet differs from a needlepunched-nonwoven carpet in that it has a higher quality look and feel, as well as improved wear characteristics.

For homogenizing the stitch pattern in a needled nonwoven, specific methods are described in U.S. Pat. No. 9,567,698 B2, US 2016/0069006 A1, U.S. Pat. No. 9,260,806 B2, US 2015/0259836 A1 and EP 2 918 719 A1. In the production of a flat needlepunched-nonwoven, staple fibers are solidified after a nonwoven formation by means of carding and crosslapping via multiple needling between two metal plates. In a further work step by means of repeated needling in a brush belt, a velour needle fleece can be produced from this flat needlepunched-nonwoven. For both variants, it is necessary to thermally or chemically bond the staple bevels after needling in order to achieve good final strength.

The fibres are mostly incorporated by means of foamed latex or acrylate. A combined use of latex or acrylate and BiCo fiber (coPET/PET bicomponent fiber) is also common in practice. Furthermore, the integration is also realized exclusively via BiCo fiber.

In particular, WO 2017/061970 A1 deals with the binding of the carpet by means of bicomponent (BiCo) fibres. Here, the optimization of the (BiCo) fiber fixation by using special slot nozzles in the drying oven is described. In addition, the following are known: spread PE, EVA/PE mixture, on extruded PE, films, hot glue, thermoplastic dispersions and thermobonding (EP 1 598 476 B1).

In DE 2 008 439 C [U.S. Pat. No. 3,755,055], a method is described in which a monochrome or melanged nonwoven web and a nonwoven web printed with pigment dyes with an ornamental pattern on one or more sides are laid on top of one another, wherein the printed side of one nonwoven web being turned away from the unprinted nonwoven web, and then both nonwoven webs are needled through from the unprinted surface to such an extent that the fibers of the unprinted nonwoven web mix with the fibers of the printed nonwoven web to form a pile on the printed surface thereof and the printed ornamental pattern thereof is changed to a soft and three-dimensional pattern.

DE 39 04 526 A1 discloses a floor covering and a method for its manufacture. For the production of the floor covering from two layers of needlepunchend-nonwoven, of which the top layer is structured on its upper side, the bottom layer is needled into the structured top layer from the underside thereof. The depth of the needling is considerably less than the thickness of the top layer. By needling the two layers together from the back of the top layer, the structure of this top layer is not destroyed. After needling, the two layers are additionally bonded by impregnation with a bonding agent through the top layer.

In EP 0 888 743 A1 [US 2002/0029445 A1, U.S. Pat. Nos. 6,287,407 B1, 6,398,895 B1], a structured textile material made of at least two different base nonwovens for the field of cleaning textiles is described. The technical teaching relates to a structured textile material made of at least two different needled base nonwovens, wherein the base nonwovens having a structure obtained by needling from at least one side, wherein the needles used for structure needling being fork or wreath needles and the depth of the forks or the wreaths, respectively, being selected such that they are completely fill with fibers of the base nonwoven facing the needles when they are pierced, and wherein the textile material having unmixed, pure fibers in the pattern, in the base and on the reverse side. In the method for producing the structured textile material, it is stated, on the one hand, that a lamination of the two needled base nonwovens having melt fibers is carried out without activating the melt fibers, that a one-sided or two-sided structure needling is then carried out, and that the melt fibers of the base nonwovens are activated after the structure needling; and, on the other hand, in that, before entry into a structural needling machine, an intermediate layer of a material capable of bonding the two base nonwovens, in particular an adhesive nonwoven, is introduced between the two needled base nonwovens having melt fibres, in that the two base nonwovens and the intermediate layer are subjected to one-sided or two-sided structural needling, and in that the bond between the two base nonwovens and the intermediate layer is then produced by activation of the melt fibres and the intermediate layer.

WO 2011/045691 A1 describes a graphic velour carpet and its manufacture. Two structuring machines, each equipped with 2 needle boards and a base and a top web, are used. The base nonwoven is fed between the two structuring machines onto the top nonwoven and needled in the second structuring machine to form a nonwoven. The needles in the needle boards are arranged in predetermined patterns. An adhesive is applied to the base web, which then fixes/bonds the fibers of the nonwoven layers.

Furthermore, it is known to create patterns in a needlefelt web by means of several components, fiber layers and several needling operations, see, inter alia, DE 103 46 473 A1 and WO 2011/065851 A1.

DE 20 2009 000 775 U1 discloses a fibrous sheet structure consisting of a needled nonwoven or fibrous pile (surface layer) on the visible side and a fibrous pile or fibrous nonwoven (pattern layer), which are bonded to one another by needling by means of different needle types/needle styles and/or needle arrangements and/or stitching directions and/or stitching depths. The pattern layer is pre-processed and differs from the surface layer in the fibers themselves and the fiber coloration. Also, the pattern layer is punched and/or cut out prior to needling with the surface layer and is dyed and/or printed. Further, several different sample piles or sample nonwovens are used as the sample layer. The surface layer is back-needled and surface-treated.

In the as yet unpublished DE 10 2019 100 916.2, a needlepunched-nonwoven carpet for motor vehicle interior trims, is produced by using different needle types over the width of the needle board. In DE 10 2019 100 919.7 and DE 10 2019 100 922.7, which are also as yet unpublished, needles of different lengths, on the one hand, and brushes of different bristle heights, on the other hand, are applied to produce structured velour carpet surfaces for motor vehicle interior trims.

In the prior art, there are no known velour carpets for motor vehicle interior trims which have 3D ornaments/carpet patterns over length and width, and which differ in height (pile height).

Thus, the object of the present invention as compared to the aforementioned prior art is to +e provide a structurally needled carpet which is suitable for deformation and which enhances the passenger compartment and/or luggage compartment and/or load compartment of motor vehicles to the extent that the latter has a “living room/well-being atmosphere”. In particular, it is an object of the invention to introduce, during the manufacture of velour carpet and/or the velourization of needlepunched-nonwoven carpet, a permanent, hard-wearing surface pattern having a three-dimensional structure which is structured differently over the width and length of the carpet surface and which withstands three-dimensional deformation to form a floor trim, luggage compartment trim or load floor trim for motor vehicles.

In a first embodiment, the subject matter of the present invention is a method for producing a three-dimensionally deformable velour carpet for a floor trim, a luggage compartment trim or a loading floor trim of a motor vehicle with a structurally needled, deformation-resistant surface having a grammage of the carpet in the range from 180 g/m² to 700 g/m², which is characterized in that

at a defined setting of the penetration depth as well as a defined setting of the penetration density, a velour carpet is produced from an initial nonwoven, wherein

a brush band is used which has, segmentally or partially, sections of different brushes and/or brush arrangements or brushes of different bristle heights,

two or more needle types of different lengths are arranged segmentally across the width of a needle board,

and one or more sublayers are added and deformed to this velour carpet.

The core of the present invention is thus the provision of a velour carpet, produced in a conventional standard process, for a floor trim, a luggage compartment trim or a load floor trim of a motor vehicle with a structurally needle-punched, deformation-resistant visible surface solely by the arrangement of needle types of different lengths over the width of the needle board and/or the needle boards and

by the arrangement of brushes of the brush band with different brush/bristle height and brush/bristle structure,

used for needling or velouring the carpet for a floor trim, a luggage compartment trim or a loading floor trim of a motor vehicle.

The surface material for an automotive interior trim itself is a velour carpet, which may have several sublayers, as well as foam or fiber/fleece insulation, toward the body.

The needle boards are loaded across the width with previously defined needle types/geometries, in particular needle lengths, and

the brush band is equipped over its width and length with predefined brush/bristle heights and/or brush/bristle structures, which thus create a predefined three-dimensional structure of the velour surface.

In a particularly preferred embodiment, needle types are used segmentally which differ not only in length but also in further parameters, such as fineness, fork opening and fork orientation.

The advantage of the present invention is to provide a deformation-resistant/stable, structurally needled velour carpet for the production of motor vehicle floor and luggage compartment trims or load floor trims without an additional working step in its production compared to standard velour carpet production.

The method of the present invention can be implemented—without additional fleece layers, needling stages, needling machines or needling boards—on “standard” installations solely by means of the brush/bristle heights and brush/bristle structures, the brush band being equipped with them over the width and length, and by means of the needle geometry/needle type, the needle length of the needles arranged across the width of the needle board.

A further embodiment of the present invention comprises a three-dimensionally shaped velour carpet for a floor trim, a luggage compartment trim or a loading floor trim of a motor vehicle with a structurally needled, deformation-resistant surface having a grammage of the carpet in the range from 180 g/m² to 700 g/m², further comprising one or more sublayers, wherein the visible side of the carpet has a three-dimensional structurally needled, durable surface-consisting of 3D ornaments/carpet patterns over length and width, which differ in height (pile height).

The realization should preferably take place on the one hand with a single-layer and on the other hand with a two-layer velour carpet. In the case of a two-layer design, additional colour effects with different structures can be needled in.

### EXAMPLE OF EXECUTION

For the production of a deformation-resistant/stable, structure-needled floor trim, a pre-fleece made of a fiber mix consisting of 80% commercially available 13 dtex fibers, fiber length 60 mm, PET fiber and 20% commercially available 6.7 dtex fibers, fiber length 64 mm, PET fiber was used as the initial nonwoven. The weight per unit area was 480 g/m².

Fork needles of different lengths from Groz-Beckert KG 15×16×20×40×73.0 D G 9077/616751 [length: 74.8 mm] and 15×17×32×40×74.8 D G 9077/615921 [length: 76.6 mm] have been installed in a needle board of the velours IV (8000 n/lm), alternately in 20 cm wide strips. The zero adjustment of the machine was matched to the longer of the two needles.

Ornaments/patterns were worked into the brushes of the brush band by shortening the brush fibres.

During production, it was important to find the optimum penetration depth and the optimum penetration density by testing the machine settings.

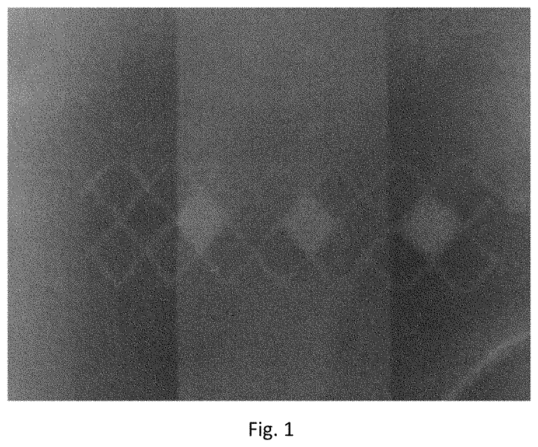

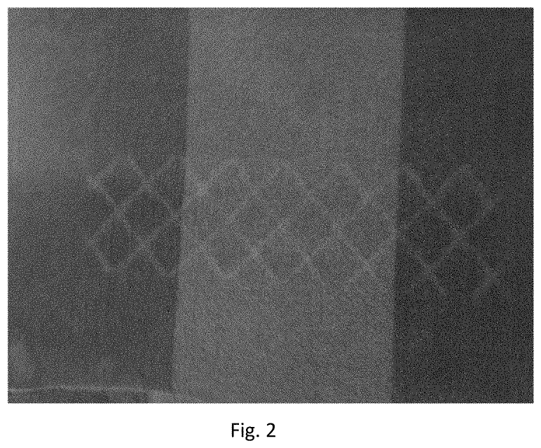

In the case of the velour carpet shown in FIG. 1 and FIG. 2, the stitch density was 600 stitches/cm², and the stitch depth 3 mm.

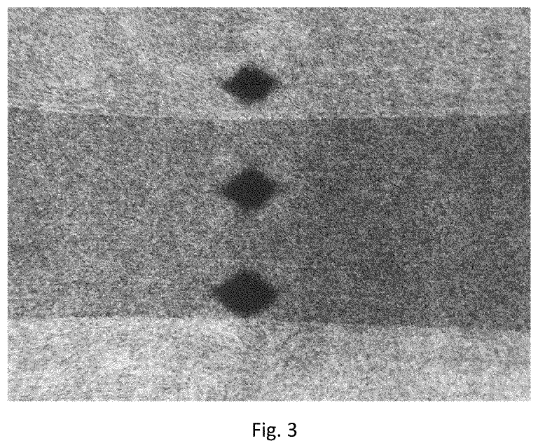

FIG. 3 shows a two-ply velour carpet (beige and black pre-fleece). Here the stitch density was 600 stitches/cm², and the stitch depth 7 mm.

1. A method for the production of a three-dimensionally deformable velour carpet for a floor trim, a luggage compartment trim or a load floor trim of a motor vehicle with a structurally needled, deformation-resistant surface having a grammage of the carpet in the range from 180 g/m² to 700 g/m², which is characterized in that
at a defined setting of the penetration depth of the needles as well as a defined setting of their penetration density, a velour carpet is produced from an initial nonwoven, wherein
a brush band is used which has, segmentally or partially, sections of different brushes and/or brush arrangements or brushes of different bristle heights,
two or more needle types of different lengths are arranged segmentally across the width of a needle board, and
this velour carpet is added and deformed with one or more sublayers.

2. The method according to claim 1, characterized in that,
the structuring of the bristles is effected by arrangement of brush segments, by different brush heights and/or by defined placement and/or removal of bristles in the band and/or dividing webs.

3. The method according to claim 1, characterized in that needles are used which differ in length, fineness, fork opening and fork orientation.

4. A three-dimensionally shaped velour carpet for a floor trim, a luggage compartment trim or a load floor trim of a motor vehicle with a structurally needled, deformation-resistant surface with a grammage of the carpet in the range from 180 g/m² to 700 g/m², further comprising one or more sublayers, wherein the visible side of the carpet has a three-dimensional structurally needled, durable surface consisting of 3D ornaments/carpet patterns over length and width which differ in height (pile height).
